(19) United States
(12) Patent Application Publication
(10) Pub. No.: US 2020/0408932 A1
(43) Pub. Date: Dec. 31, 2020

(54) RADIATION DETECTOR AND RADIOGRAPHIC IMAGE CAPTURING APPARATUS

(71) Applicant: FUJIFILM Corporation, Tokyo (JP)

(72) Inventors: Naoto IWAKIRI, Kanagawa (JP); Haruyasu NAKATSUGAWA, Kanagawa (JP)

(73) Assignee: FUJIFILM Corporation, Tokyo (JP)

(21) Appl. No.: 17/017,798

(22) Filed: Sep. 11, 2020

Related U.S. Application Data
(63) Continuation of application No. PCT/JP2019/010645, filed on Mar. 14, 2019.

(30) Foreign Application Priority Data
Mar. 27, 2018 (JP) 2018-060763

(51) Int. Cl. G01T 1/20; G01T 1/29

(52) U.S. Cl. CPC G01T 1/2006; G01T 1/2018; G01T 1/2985

(57) ABSTRACT

A radiation detector includes a substrate having a light-transmitting property, a plurality of pixels provided on the substrate, a scintillator laminated on a side of a first surface of the substrate, and a light detector laminated on a side of a second surface of the substrate opposite to the first surface and including a photoelectric conversion film. An absorption peak wavelength, which is a wavelength having a highest absorbance, in a wavelength range of light absorbed by the photoelectric conversion film exists within an emission wavelength range which is a wavelength range of light emitted from the scintillator and is out of an absorption wavelength range which is a wavelength range of light absorbed by the substrate.

### CROSS-REFERENCE TO RELATED APPLICATIONS

This application is a continuation application of International Application No. PCT/JP2019/010645 filed Mar. 14, 2019, the disclosure of which is incorporated herein by reference in its entirety. Further, this application claims priority from Japanese Patent Application No. 2018-060763, filed Mar. 27, 2018, the disclosure of which is incorporated herein by reference in its entirety.

### BACKGROUND

### Technical Field

The disclosed technology relates to a radiation detector and a radiographic image capturing apparatus.

### Related Art

The following technology is known as a technology relating to a radiographic image capturing apparatus. For example, JP2015-172590A discloses a radiation detection panel in which a scintillator that absorbs radiation transmitted through a subject and emits light, a first detection unit that detects light emitted from the scintillator as an image, and a second detection unit that is formed from an organic photoelectric conversion material and detects light emitted from the scintillator are laminated along an incident direction of radiation.

As a radiation detector used in a radiographic image capturing apparatus, a radiation detector including a substrate, a plurality of pixels which are provided on the substrate and each of which includes a photoelectric conversion element, and a scintillator laminated on the substrate is known. In recent years, a material having a flexibility and a light-transmitting property such as a resin film is used as a material of a substrate forming a radiation detector.

On the other hand, in the radiographic image capturing apparatus, it is necessary to perform synchronization control between the radiation detector and a radiation source so that the radiation detector starts an accumulation operation of accumulating a signal charge in synchronization with an irradiation timing at which the radiation source emits radiation. In order to synchronize the timing at which irradiation with radiation is started with the timing at which the radiation detector starts the signal charge accumulation operation, a control device such as a console for controlling the radiographic image capturing apparatus, in a case of receiving an irradiation start signal generated by an irradiation switch connected to the radiation source, supplies a synchronization signal to the radiographic image capturing apparatus. In a case where the synchronization signal is received, the radiographic image capturing apparatus shifts to the accumulation operation.

In a case where an imaging system including a radiographic image capturing apparatus and a radiation source is configured, an interface for synchronization control (a standard for a cable and a connector, a format of a synchronization signal, or the like) that is standardly equipped in the radiographic image capturing apparatus and a console thereof may not be compatible with an interface of the radiation source. Under such a circumstance, a radiographic image capturing apparatus having a function of detecting irradiation with radiation by itself without using a synchronization signal is developed.

As a configuration of the radiation detector used in the radiographic image capturing apparatus having the function described above, for example, the following configuration is assumed. For example, a radiation detector comprising a substrate having a light-transmitting property, a plurality of pixels which are provided on the substrate and each of which includes a first photoelectric conversion element, a scintillator laminated on a side of a first surface of the substrate, and a light detector which is laminated on a side of a second surface of the substrate opposite to the first surface and includes a second photoelectric conversion element different from the first photoelectric conversion element is assumed.

According to the above configuration of the radiation detector, light emitted from the scintillator is made incident on the light detector via the substrate. Therefore, in a case where a relationship among a wavelength of light emitted from the scintillator, a wavelength of light absorbed by the light detector, and a wavelength of light absorbed by the substrate is inappropriate, it is difficult for the light detector to appropriately detect light emitted from the scintillator.

### SUMMARY

An object of the disclosed technology is to enable the light detector to appropriately detect light emitted from the scintillator in a configuration in which light emitted from the scintillator is transmitted through the substrate and is made incident on the light detector.

A radiation detector according to a first aspect of the disclosed technology comprises: a substrate having a light-transmitting property; a plurality of pixels provided on the substrate; a scintillator laminated on a side of a first surface of the substrate; and a light detector laminated on a side of a second surface of the substrate opposite to the first surface and including a photoelectric conversion film. An absorption peak wavelength, which is a wavelength having a highest absorbance, in a wavelength range of light absorbed by the photoelectric conversion film exists within an emission wavelength range which is a wavelength range of light emitted from the scintillator and is out of an absorption wavelength range which is a wavelength range of light absorbed by the substrate.

### BRIEF DESCRIPTION OF THE DRAWINGS

FIG. 1 is a perspective view illustrating an example of a configuration of a radiographic image capturing apparatus according to an embodiment of the disclosed technology.

FIG. 2 is a cross-sectional view illustrating the example of the configuration of the radiographic image capturing apparatus according to the embodiment of the disclosed technology.

FIG. 3 is a view illustrating an example of an electric configuration of the radiographic image capturing apparatus according to the embodiment of the disclosed technology.

FIG. 4 is a view illustrating an example of a hardware configuration of a cassette control section according to the embodiment of the disclosed technology.

FIG. 5 is a flowchart illustrating an example of a flow of mode shift control processing executed in the cassette control section according to the embodiment of the disclosed technology.

FIG. 6 is a view illustrating an example of a relationship among an emission wavelength of a scintillator, an absorption wavelength of a photoelectric conversion film, and an absorption wavelength of a TFT substrate according to the embodiment of the disclosed technology.

FIG. 7 is a view illustrating an example of wavelength characteristics of an emission intensity of the scintillator, a light absorbance of the photoelectric conversion film, and a light transmittance of the TFT substrate according to the embodiment of the disclosed technology.

FIG. 8A is an enlarged cross-sectional view of a part of a radiation detector according to the embodiment of the disclosed technology.

FIG. 8B is an enlarged cross-sectional view of a part of the radiation detector according to the embodiment of the disclosed technology.

### DETAILED DESCRIPTION

Hereinafter, an example of an embodiment of the disclosed technology will be described with reference to the drawings. In each drawing, the same or equivalent constituent elements and parts are designated by the same reference numerals.

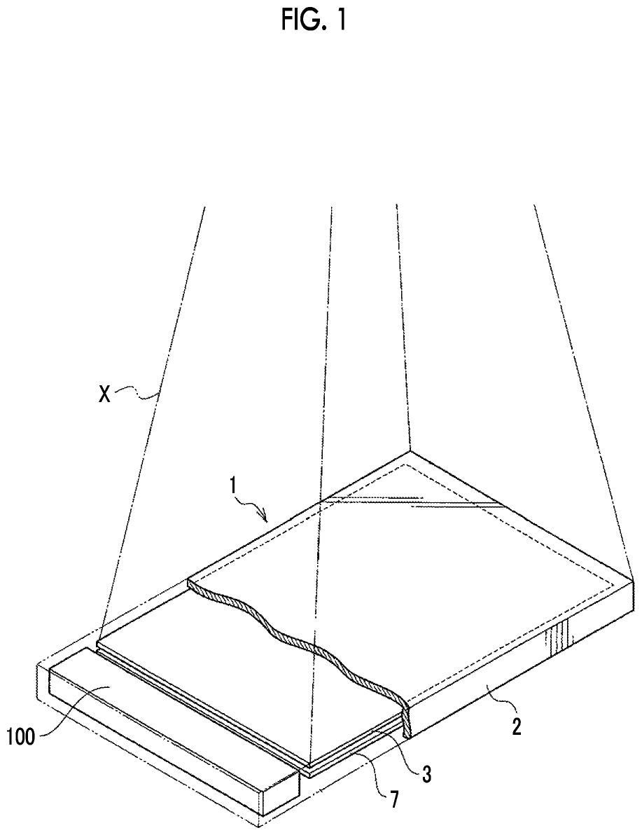

FIG. 1 is a perspective view illustrating an example of a configuration of a radiographic image capturing apparatus 1 according to an embodiment of the disclosed technology. The radiographic image capturing apparatus 1 has a form of a portable electronic cassette. The radiographic image capturing apparatus 1 is configured to include a radiation detector 3 (flat panel detector (FPD)), a control unit 100, a support plate 7, and a casing 2 for housing these.

The casing 2 has, for example, a monocoque structure made of a carbon fiber reinforced resin (carbon fiber) that has a high transmissivity of radiation such as an X-ray, is light-weight, and has a high durability. An upper surface of the casing 2 is a radiation incident surface on which radiation emitted from a radiation source (not shown) and transmitted through a subject (not shown) is incident. In the casing 2, the radiation detector 3 and the support plate 7 are disposed in order from the radiation incident surface side.

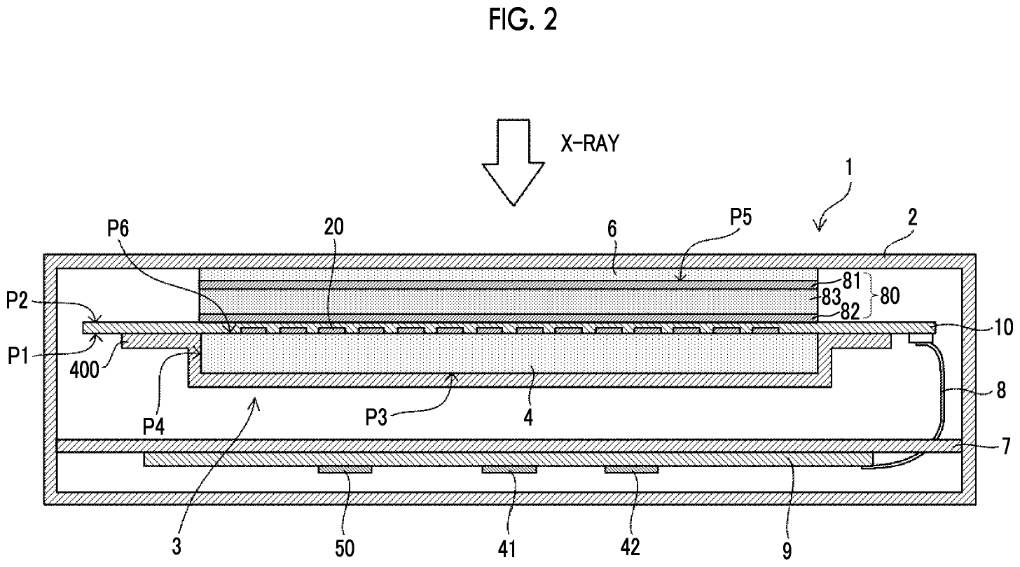

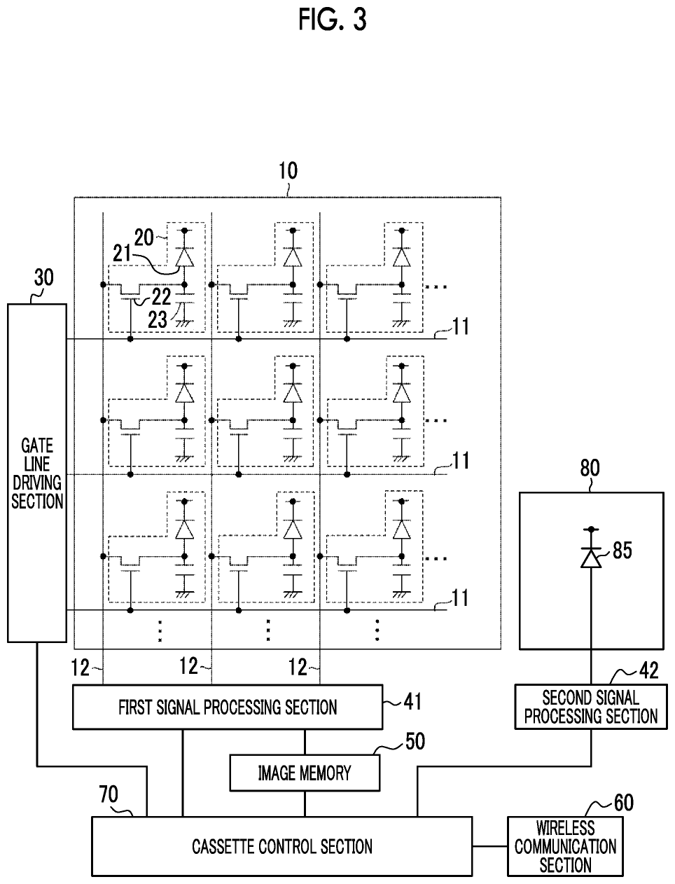

The support plate 7 supports a circuit board 9 (see FIG. 2) on which an integrated circuit chip that performs signal processing or the like is mounted, and is fixed to the casing 2. The control unit 100 is disposed at an end of the casing 2 and is configured to include a battery (not shown) and a cassette control section 70 (see FIG. 3).

FIG. 2 is a cross-sectional view illustrating the example of the configuration of the radiographic image capturing apparatus 1. The radiation detector 3 is configured to include a thin-film-transistor (TFT) substrate 10, a plurality of pixels 20 provided on a surface of the TFT substrate 10 and including a photoelectric conversion element 21 (see FIG. 3), a scintillator 4 laminated on a side of a first surface P1 of the TFT substrate 10, and a light detection section 80 laminated on a side of a second surface P2 of the TFT substrate 10 opposite to the side of the first surface P1.

The TFT substrate 10 is a flexible substrate having a light-transmitting property and a flexibility. In the present specification, the term “the TFT substrate 10 having a flexibility” means that in a case where one of four sides of the rectangular TFT substrate 10 is fixed, a height of a portion away from the fixed side of the TFT substrate 10 by 10 cm is lower than a height of the fixed side due to a weight of the TFT substrate 10 by 2 mm or more. For example, the TFT substrate 10 may be a resin substrate, and a resin film such as Xenomax (registered trademark) which is a highly heat-resistant polyimide film can be satisfactorily used. The resin film is used as a material of the TFT substrate 10, whereby, as compared to a case of using a glass substrate as the material of the TFT substrate 10, a weight and a cost of the radiation detector 3 can be reduced, and further, a risk of damaging the TFT substrate 10 due to impact can be reduced. Each of the plurality of pixels 20 is provided on the first surface P1 of the TFT substrate 10.

The scintillator 4 is laminated on the side of the first surface P1 of the TFT substrate 10. The scintillator 4 includes a phosphor that converts emitted radiation into light. The scintillator 4 is formed of an aggregate of columnar crystals containing CsI:Tl (cesium iodide added with thallium) as an example. Columnar crystals of CsI:Tl can be formed directly on the TFT substrate 10 by, for example, a vapor phase growth method. Note that columnar crystals of CsI:Tl formed on a substrate different from the TFT substrate 10 may be stuck to the TFT substrate 10. In addition, Gd₂O₂S:Tb (gadolinium oxysulfide added with terbium) can be used as a material of the scintillator 4. Each of the photoelectric conversion elements 21 (see FIG. 3) forming the plurality of pixels 20 generates a charge based on light emitted from the scintillator 4.

A surface P3 of the scintillator 4 opposite to a surface P6 in contact with the TFT substrate 10 and a surface P4 intersecting with the surface P3 are covered with a reflective film 400. The reflective film 400 has a function of reflecting light emitted from the scintillator 4 toward the TFT substrate 10 side. As a material of the reflective film 400, for example, Al₂O₃ can be used. The reflective film 400 covers the surfaces P3 and P4 of the scintillator 4 and also covers the TFT substrate 10 in a peripheral portion of the scintillator 4. In a case where a radiographic image having a desired image quality can be obtained in the radiographic image capturing apparatus 1 even though the reflective film 400 is not provided, the reflective film 400 can be omitted.

In the present embodiment, the radiographic image capturing apparatus 1 employs an imaging method by a front surface reading method (irradiation side sampling (ISS)) in which the TFT substrate 10 is disposed on the radiation incident side. The front surface reading method is employed, whereby, as compared to a case of employing a back surface reading method (penetration side sampling (PSS)) in which the scintillator 4 is disposed on the radiation incident side, a distance between a strong emission position in the scintillator 4 and the pixel 20 can be shortened, and as a result, a resolution of a radiographic image can be increased. The radiographic image capturing apparatus 1 may employ a back surface reading method.

The support plate 7 is disposed on a side of the scintillator 4 opposite to the radiation incident side. A gap is provided between the support plate 7 and the scintillator 4. The support plate 7 is fixed to a side portion of the casing 2. The circuit board 9 is provided on a surface of the support plate 7 opposite to the scintillator 4 side. A first signal processing section 41 that generates image data, an image memory 50 that stores the image data generated by the first signal processing section 41, a second signal processing section 42 that processes a signal based on a charge generated in the light detection section 80, and the like (such as their circuitries) are mounted on the circuit board 9.

The circuit board 9 and the TFT substrate 10 are electrically connected to each other via a wiring that is printed on a flexible printed board (flexible printed circuit (FPC)), a tape carrier package (TCP)), or a chip on film (COF) 8. A gate line driving section 30 (see FIG. 3) is mounted on another COF (not shown in FIG. 2) that electrically connects the circuit board 9 and the TFT substrate 10 to each other.

The light detection section 80 is laminated on the side of the second surface P2 of the TFT substrate 10 opposite to the first surface P1. The light detection section 80 is configured to include a first conductive film 81, a second conductive film 82, and a photoelectric conversion film 83 provided between the first conductive film 81 and the second conductive film 82. A photoelectric conversion element 85 (see FIG. 3) is configured by interposing the photoelectric conversion film 83 between the first conductive film 81 and the second conductive film 82. Light emitted from the scintillator 4 is transmitted through the TFT substrate 10 and is made incident on the light detection section 80. The photoelectric conversion film 83 of the light detection section 80 generates an amount of charge according to the amount of incident light. An organic photoelectric conversion material can be used as a material of the photoelectric conversion film 83. An example of the organic photoelectric conversion material is quinacridone. In the radiographic image capturing apparatus 1, the light detection section 80 is used to determine the presence or absence of irradiation with radiation from a radiation source (not shown).

In a case where the light detection section 80 detects irradiation with radiation, a bias voltage is applied to the photoelectric conversion film 83. The bias voltage is applied to the photoelectric conversion film 83 via the first conductive film 81 and the second conductive film 82. The first conductive film 81 and the second conductive film 82 may be patterned. By patterning the first conductive film 81 and the second conductive film 82, a plurality of photoelectric conversion elements may be configured in the light detection section 80.

The first conductive film 81 and the second conductive film 82 preferably have a radiation transmittance of 90% or more so that radiation incident on the scintillator 4 is not blocked by the first conductive film 81 and the second conductive film 82. For example, in a case where an X-ray source for general imaging (using a tungsten tube, a tube voltage of 50 kV (peak to peak)) is used as a radiation source, the first conductive film 81 and the second conductive film 82 are made of aluminum having a thickness of 25 μm or less or copper having a thickness of 0.9 μm or less, whereby a transmittance for an X-ray can be made to 99% or more. In addition, in a case where an X-ray source for mammography imaging (using a molybdenum tube and a molybdenum filter (32 μm), a tube voltage of 24 kV (peak to peak)) is used as a radiation source, the first conductive film 81 and the second conductive film 82 are made of aluminum having a thickness of 4 μm or less, whereby a transmittance for an X-ray can be made to 99% or more. A surface P5 of the light detection section 80 opposite to a contact surface with the TFT substrate 10 is stuck to an inner wall of the casing 2 with an adhesion layer 6 interposed therebetween.

FIG. 3 is a view illustrating the example of the electric configuration of the radiographic image capturing apparatus 1. The plurality of pixels 20 arranged in a matrix are provided on the TFT substrate 10. Each of the plurality of pixels 20 is configured to include the photoelectric conversion element 21, a capacitor 23, and a thin film transistor 22. The photoelectric conversion element 21 may be, for example, a photodiode including amorphous silicon. Each of the photoelectric conversion elements 21 has a cathode connected to a bias wiring (not shown) to which a bias voltage is applied, and an anode connected to a source of the corresponding thin film transistor 22. The capacitor 23 has one end connected to a source of the corresponding thin film transistor 22 and the other end connected to a ground line.

A plurality of gate wirings 11 and a plurality of signal wirings 12 intersecting with each of the gate wirings 11 are provided on the TFT substrate 10. The plurality of gate wirings 11 and the plurality of signal wirings 12 are arranged along an array of the plurality of pixels 20. Each of the gate wirings 11 is connected to the gate line driving section 30 and a gate of the thin film transistor 22. Each of the signal wirings 12 is connected to the first signal processing section 41 and a drain of the thin film transistor 22.

The gate line driving section 30 operates in any one of three operation modes of a standby mode, an accumulation mode, and a read-out mode. The standby mode is a mode selected in a case where the radiographic image capturing apparatus 1 is on standby for irradiation with radiation from a radiation source (not shown). In the standby mode, the gate line driving section 30 controls each of the thin film transistors 22 so that each of the thin film transistors 22 is repeatedly turned on and off at a regular interval. Thereby, a charge generated in each of the photoelectric conversion elements 21 included in each of the pixels 20 is intermittently removed from the pixel 20. By this processing, an influence of a dark current caused by a charge generated in each pixel 20 during non-irradiation with radiation is not irradiated is suppressed. An on or off state of the thin film transistor 22 is controlled by a drive signal output from the gate line driving section 30 and input to the gate of the thin film transistor 22 via the gate wiring 11.

The accumulation mode is an operation mode selected in a case where the radiographic image capturing apparatus 1 detects irradiation with radiation from a radiation source (not shown). In the accumulation mode, the gate line driving section 30 controls all the thin film transistors 22 to be an off-state. Thereby, a charge generated in each of the photoelectric conversion elements 21 included in each of the pixels 20 is accumulated in the corresponding capacitor 23.

The read-out mode is an operation mode selected in a case where a radiographic image is acquired based on a charge accumulated in each of the pixels 20. In the read-out mode, the gate line driving section 30 sequentially controls the thin film transistors 22 to be an on-state in row units. A charge read out by the thin film transistor 22 in the on-state is input to the first signal processing section 41 as an electric signal via each signal wiring 12.

The first signal processing section 41 is configured to include a charge amplifier, a sample-and-hold circuit, a multiplexer, and an A/D converter, which are not shown. The charge amplifier generates an electric signal having a voltage level according to the amount of charge read out from each pixel 20 via each signal wiring 12. A signal level of the electric signal generated by the charge amplifier is held in the sample-and-hold circuit. Each output terminal of the sample-and-hold circuit is connected to the common multiplexer. The multiplexer converts the signal level held in the sample-and-hold circuit into serial data and supplies the serial data to the analog/digital (A/D) converter. The A/D converter converts an analog electric signal supplied from the multiplexer into a digital signal. The first signal processing section 41 generates image data in which the digital signal output from the A/D converter is associated with a coordinate position of each pixel 20.

The image memory 50 is connected to the first signal processing section 41, and the image data generated by the first signal processing section 41 is stored in the image memory 50. The image memory 50 has a storage capacity capable of storing a predetermined piece of image data, and pieces of image data obtained by imaging are sequentially stored in the image memory 50 each time a radiographic image is captured.

A wireless communication section 60 controls transmission of various types of information by wireless communication with an external equipment. The cassette control section 70 can wirelessly communicate with an external device such as a console (not shown) for controlling capturing of a radiographic image via the wireless communication section 60, and can transmit and receive various types of information to and from the external equipment.

The light detection section 80 has the photoelectric conversion element 85 including the first conductive film 81, the second conductive film 82, and the photoelectric conversion film 83. The photoelectric conversion element 85 generates an amount of charge according to the amount of incident light. The photoelectric conversion element 85 may be, for example, a photodiode. The photoelectric conversion element 85 has a cathode connected to a bias wiring (not shown) to which a bias voltage is applied, and an anode connected to the second signal processing section 42. Although FIG. 3 illustrates a form in which the light detection section 80 has the single photoelectric conversion element 85, the light detection section 80 may have a form in which a plurality of the photoelectric conversion elements 85 are arranged in a matrix.

The second signal processing section 42 has the same configuration as the first signal processing section 41. The second signal processing section 42 generates an electric signal having a voltage level according to the amount of charge generated by the photoelectric conversion element 85 of the light detection section 80, and outputs a light detection signal obtained by converting the electric signal into a digital signal. That is, the light detection signal indicates an intensity of light incident on the light detection section 80. The light detection signal is supplied to the cassette control section 70.

The cassette control section 70 is communicatively connected to the gate line driving section 30, the first signal processing section 41, the second signal processing section 42, the image memory 50, and the wireless communication section 60, and integrally controls the operation of the whole of the radiographic image capturing apparatus 1.

The radiographic image capturing apparatus 1 has a function of determining the presence or absence of irradiation with radiation from a radiation source (not shown). This function is realized by the cassette control section 70 performing mode shift control processing which will be described below.

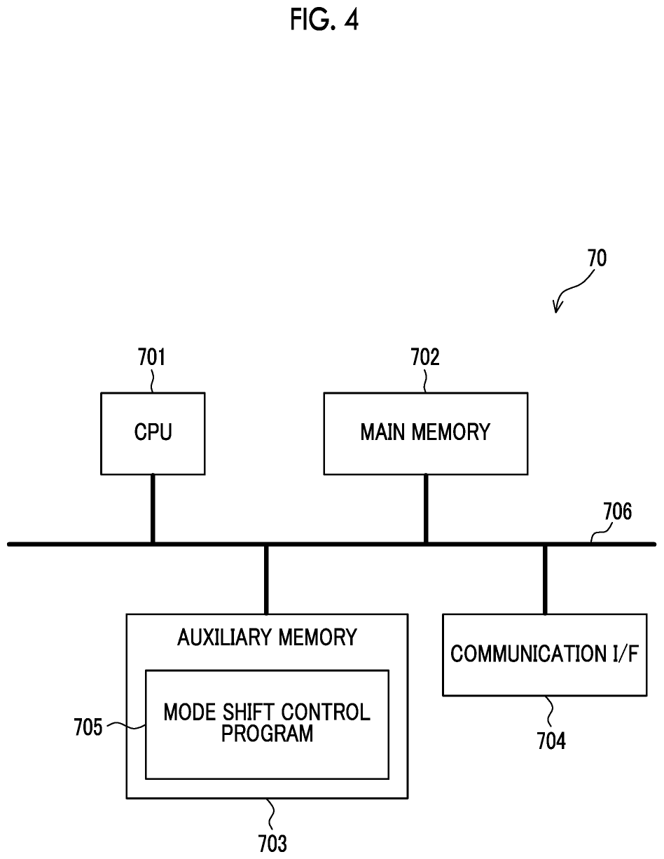

Here, FIG. 4 is a view illustrating an example of a hardware configuration of the cassette control section 70. The cassette control section 70 includes a computer comprising a central processing unit (CPU) 701, a main memory 702 as a temporary storage area, a non-volatile auxiliary memory 703, and a communication interface (I/F) 704. The communication I/F 704 is an interface for communicating among the gate line driving section 30, the first signal processing section 41, the second signal processing section 42, the image memory 50, and the wireless communication section 60. The CPU 701, the main memory 702, the auxiliary memory 703, and the communication I/F 704 are each connected to a bus 706. The auxiliary memory 703 stores a mode shift control program 705 which describes the procedure of the mode shift control processing described above. The cassette control section 70 functions as a mode shift control section in a case where the CPU 701 executes the mode shift control program 705.

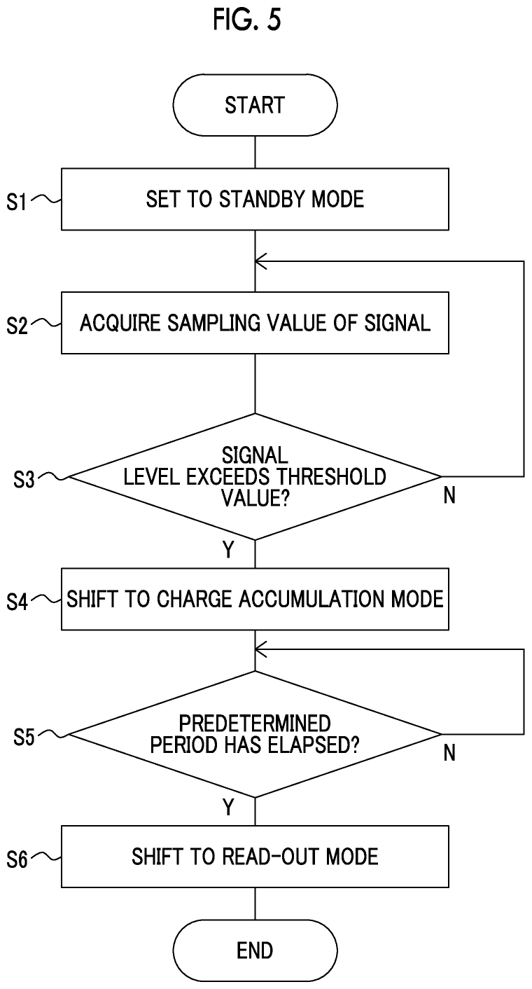

FIG. 5 is a flowchart illustrating an example of a flow of the mode shift control processing executed in the cassette control section 70.

For example, in a case where an operation of providing an instruction to start capturing of a radiographic image is performed to the radiographic image capturing apparatus 1, the CPU 701 sets the operation mode of the gate line driving section 30 to the standby mode in step S1.

In step S2, the CPU 701 acquires a sampling value of an electric signal based on a charge generated in the photoelectric conversion element 85 of the light detection section 80 from the second signal processing section 42.

In step S3, the CPU 701 determines whether or not a level of the electric signal exceeds a threshold value based on the sampling value of the electric signal. In a case where the CPU 701 determines that the level of the electric signal does not exceed the threshold value, the processing is returned to step S2 on the assumption that radiation is not emitted, and in a case where the CPU 701 determines that the level of the electric signal exceeds the threshold value, the processing shifts to step S4 on the assumption that radiation is emitted.

In a case where radiation is emitted from a radiation source (not shown), the scintillator 4 absorbs radiation and emits light. Light emitted from the scintillator 4 is transmitted through the TFT substrate 10 and is made incident on the light detection section 80. The light detection section 80 generates an amount of charge according to the amount of light emitted from the scintillator 4. In a case where radiation is emitted from a radiation source (not shown), a level of an electric signal based on a charge generated in the light detection section 80 exceeds the threshold value used for the determination in step S3.

In step S4, the CPU 701 supplies a control signal to the gate line driving section 30 to make the operation mode of the gate line driving section 30 shift to the accumulation mode. Thereby, the gate line driving section 30 turns off all the thin film transistors 22. Thereby, a charge generated in each of the photoelectric conversion elements 21 included in each of the pixels 20 in accordance with irradiation with radiation is accumulated in the corresponding capacitor 23.

In step S5, the CPU 701 determines whether or not a predetermined period has elapsed after the operation mode of the gate line driving section 30 shifts to the accumulation mode. The predetermined period is set to a time sufficient for recording pixel information of a radiographic image in the pixel 20. In a case where the CPU 701 determines that a predetermined period has elapsed after the operation mode of the gate line driving section 30 shifts to the accumulation mode, the processing shifts to step S6.

In step S6, the CPU 701 supplies a control signal to the gate line driving section 30 to make the operation mode of the gate line driving section 30 shift to the read-out mode. Thereby, the gate line driving section 30 sequentially controls the thin film transistors 22 to be an on-state in row units. A charge read out by the thin film transistor 22 in the on-state is input to the first signal processing section 41 via each signal wiring 12. The first signal processing section 41 generates image data based on a charge read out from each pixel 20. The image data generated by the first signal processing section 41 is stored in the image memory 50.

In this way, in a case where light emitted from the scintillator 4 and transmitted through the TFT substrate 10 is made incident on the light detection section 80, and a level of a signal based on a charge generated in the light detection section 80 exceeds the threshold value, the mode shifts to the accumulation mode on the assumption that radiation is emitted from a radiation source (not shown).

In order to increase an accuracy of detection of irradiation with radiation, it is preferable to increase the absorption efficiency of light emitted from the scintillator 4 in the photoelectric conversion film 83. In order to increase the absorption efficiency of light emitted from the scintillator 4 in the photoelectric conversion film 83, it is necessary to appropriately determine a relationship among a wavelength of light emitted from the scintillator 4 (hereinafter, referred to as an emission wavelength of the scintillator 4), a wavelength of light absorbed by the photoelectric conversion film 83 of the light detection section 80 (hereinafter, referred to as an absorption wavelength of the photoelectric conversion film 83), and a wavelength of light absorbed by the TFT substrate 10 (hereinafter, referred to as an absorption wavelength of the TFT substrate 10).

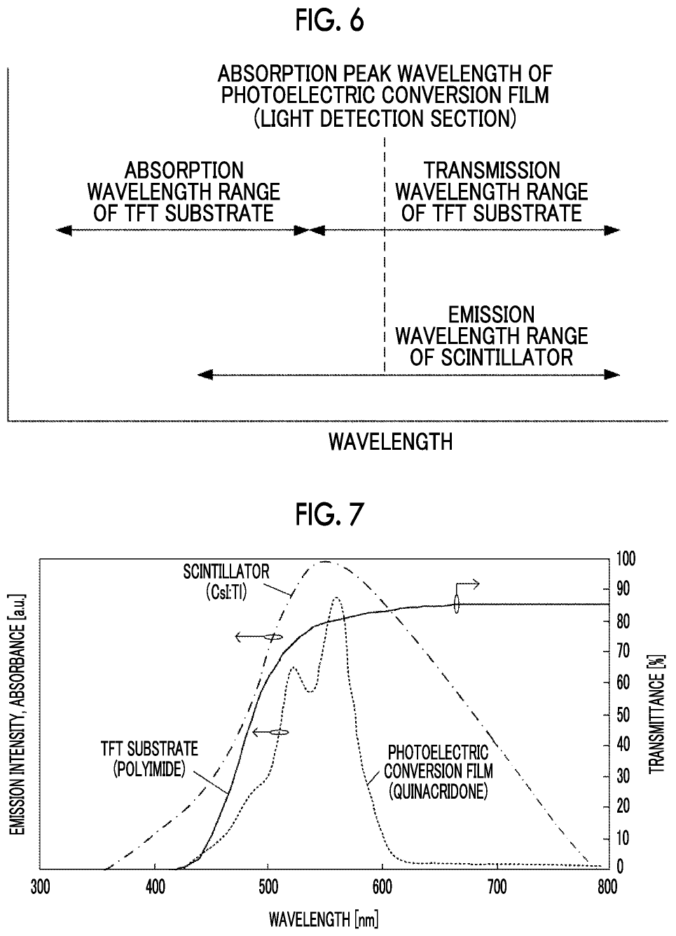

FIG. 6 is a view illustrating an example of a relationship among an emission wavelength of the scintillator 4, an absorption wavelength of the photoelectric conversion film 83, and an absorption wavelength of the TFT substrate 10. As shown in FIG. 6, an absorption peak wavelength, which is a wavelength having the highest absorbance, in an absorption wavelength range of the photoelectric conversion film 83 exists within an emission wavelength range of the scintillator 4. In addition, the absorption peak wavelength of the photoelectric conversion film 83 is out of an absorption wavelength range of the TFT substrate 10. In other words, the absorption peak wavelength of the photoelectric conversion film 83 exists within a transmission wavelength range of the TFT substrate 10.

By determining the relationship among the emission wavelength of the scintillator 4, the absorption wavelength of the photoelectric conversion film 83, and the absorption wavelength of the TFT substrate 10 as described above, most of wavelength components corresponding to the absorption peak wavelength of the photoelectric conversion film 83 out of light emitted from the scintillator 4 transmit through the TFT substrate 10 and reach the photoelectric conversion film 83. In addition, light reaching the photoelectric conversion film 83 is efficiently absorbed by the photoelectric conversion film 83. Therefore, according to the radiation detector 3 according to the embodiment of the disclosed technology, the light detection section 80 can appropriately detect light emitted from the scintillator 4.

For example, in a case where an emission peak wavelength, which is a wavelength having the highest emission intensity, in the emission wavelength range of the scintillator 4 is about 550 nm, it is preferable that an absorption wavelength edge which is an edge of the absorption wavelength range of the TFT substrate 10 is less than 500 nm and the absorption peak wavelength of the photoelectric conversion film 83 of the light detection section 80 is 500 nm or more. As the TFT substrate 10, for example, a polyimide film having an absorption wavelength edge of less than 500 nm can be used. As a material of the photoelectric conversion film 83, quinacridone having an absorption peak wavelength of 500 nm or more can be used. As a material of the scintillator 4, CsI:Tl and Gd₂O₂S:Tb having an emission peak wavelength around 550 nm can be used.

The closer the absorption peak wavelength of the photoelectric conversion film 83 is to the emission peak wavelength of the scintillator 4, the more preferable it is. Thereby, the absorption efficiency of light emitted from the scintillator 4 in the photoelectric conversion film 83 can be further increased. A difference between the absorption peak wavelength of the photoelectric conversion film 83 and the emission peak wavelength of the scintillator 4 is preferably 10 nm or less and more preferably 5 nm or less.

A width of a deviation between the emission peak wavelength of the scintillator 4 and the absorption wavelength edge of the TFT substrate 10 is preferably 100 nm or more. Thereby, absorption of light emitted from the scintillator 4 by the TFT substrate 10 can be suppressed, and more light beams can reach the light detection section 80.

In a case where a polyimide film is used as a material of the TFT substrate 10 and an X-ray source for general imaging (using a tungsten tube, a tube voltage of 50 kV (peak to peak)) is used as a radiation source, a thickness of the TFT substrate 10 is preferably 0.2 mm or less. On the other hand, in a case where a polyimide film is used as a material of the TFT substrate 10 and an X-ray source for mammography imaging (using a molybdenum tube and a molybdenum filter (32 μm), a tube voltage of 24 kV (peak to peak)) is used as a radiation source, a thickness of the TFT substrate 10 is preferably 0.1 mm or less. Thereby, a transmittance of the TFT substrate 10 formed of a polyimide film for an X-ray can be made to 99% or more. In addition, absorption of light emitted from the scintillator 4 can be suppressed.

FIG. 7 is a view illustrating an example of wavelength characteristics of an emission intensity of the scintillator 4, a light absorbance of the photoelectric conversion film 83, and a light transmittance of the TFT substrate 10. FIG. 7 illustrates a case where CsI:Tl is used as a material of the scintillator 4, a polyimide film is used as a material of the TFT substrate 10, and quinacridone is used as a material of the photoelectric conversion film 83. Respective constituent materials of the scintillator 4, the TFT substrate 10, and the photoelectric conversion film 83, the absorption peak wavelength of the photoelectric conversion film 83 are appropriately selected, whereby the absorption peak wavelength of the photoelectric conversion film 83 can be made to exist within the emission wavelength range of the scintillator 4 and can be made to be out of the absorption wavelength range of the TFT substrate 10.

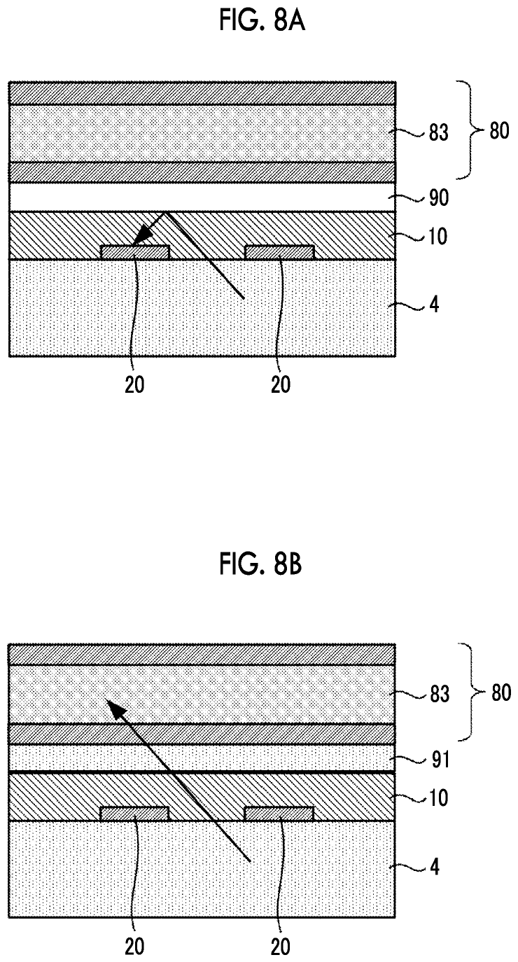

FIG. 8A is a cross-sectional view illustrating a part of the radiation detector 3 in an enlarged manner. In a case where the light detection section 80 is mounted on the TFT substrate 10 by, for example, pressure bonding, an air layer 90 is formed between the TFT substrate 10 and the light detection section 80. In this case, light emitted from the scintillator 4 and transmitted through the TFT substrate 10 may be reflected at an interface between the TFT substrate 10 and the air layer 90 due to a refractive index difference therebetween, and the reflected light may be made incident on the pixel 20. As a result, an image quality of a radiographic image may deteriorate. In a case where a film-shaped member such as a polyimide film having a smaller thickness (a thickness of about 40 μm) than a glass substrate in the related art (a thickness of about 0.5 mm) is used as the TFT substrate 10, a refractive index thereof is larger than that of glass and a refractive index difference with respect to the air layer is increased, and therefore, the problem of image quality deterioration due to interface reflection described above is more remarkable.

Therefore, in order to suppress formation of an air layer between the TFT substrate 10 and the light detection section 80, as shown in FIG. 8B, an adhesion layer 91 including an adhesive is preferably provided between the TFT substrate 10 and the light detection section 80. The adhesion layer 91 preferably has a high transmissivity (for example, a transmittance of 70% or more) with respect to each of the emission peak wavelength of the scintillator 4 and the absorption peak wavelength of the photoelectric conversion film 83 of the light detection section 80.

In order to promote an effect of suppressing interface reflection, a refractive index difference between the TFT substrate 10 and the adhesion layer 91 is preferably 10% or less, and more preferably 6.4% or less. In a case where a refractive index difference between the TFT substrate 10 and the adhesion layer 91 is set to 10% or less, an incidence angle (critical angle) of light that reaches total reflection at an interface between the TFT substrate 10 and the adhesion layer 91 can be set to 65° or more, and in a case where a refractive index difference between the TFT substrate 10 and the adhesion layer 91 is set to 6.4% or less, a critical angle can be set to 70° or more. By increasing the critical angle, reflection of light at an interface between the TFT substrate 10 and the adhesion layer 91 can be suppressed. Similarly, a refractive index difference between the light detection section 80 and the adhesion layer 91 is preferably 10% or less, and more preferably 6.4% or less. In a case where a refractive index difference between the light detection section 80 and the adhesion layer 91 is set to 10% or less, an incidence angle (critical angle) of light that reaches total reflection at an interface between the light detection section 80 and the adhesion layer 91 can be set to 65° or more, and in a case where a refractive index difference between the light detection section 80 and the adhesion layer 91 is set to 6.4% or less, a critical angle can be set to 70° or more. By increasing the critical angle, reflection of light at an interface between the light detection section 80 and the adhesion layer 91 can be suppressed. For example, in a case where a polyimide film (a refractive index of 1.65 to 1.75) is used as the TFT substrate, an adhesive having a refractive index of about 1.50 to 1.65 may be used as a material of the adhesion layer 91. For example, an epoxy resin adhesive can be used as a material of the adhesion layer 91.

The gate line driving section 30 is an example of an operation control section according to the disclosed technology. The cassette control section 70 is an example of a mode shift control section. The first signal processing section 41 is an example of a generation section in the disclosed technology. The TFT substrate 10 is an example of a substrate in the disclosed technology. The light detection section 80 is an example of a light detection section in the disclosed technology. The scintillator 4 is an example of a scintillator in the disclosed technology. The pixel 20 is an example of a pixel in the disclosed technology.

All documents, patent applications, and technical standards described in this specification are herein incorporated by reference to the same extent that each individual document, patent application, or technical standard was specifically and individually indicated to be incorporated by reference.

In the radiation detector according to a second aspect of the disclosed technology, the substrate may be configured to include a polyimide having an absorption wavelength edge which is an edge of the absorption wavelength range of less than 500 nm, and the absorption peak wavelength of the photoelectric conversion film may be 500 nm or more.

In the radiation detector according to the third aspect of the disclosed technology, a width of a deviation between an emission peak wavelength, which is a wavelength having a highest emission intensity, in the emission wavelength range of the scintillator and an absorption wavelength edge which is an edge of the absorption wavelength range of the substrate may be 100 nm or more.

The radiation detector according to a fourth aspect of the disclosed technology may further comprise an adhesion layer provided between the substrate and the light detector.

In the radiation detector according to a fifth aspect of the disclosed technology, it is preferable that a refractive index difference between the substrate and the adhesion layer and a refractive index difference between the light detector and the adhesion layer are each 10% or less.

In the radiation detector according to a sixth aspect of the disclosed technology, the substrate may be configured to include a polyimide film having a thickness of 0.2 mm or less.

A radiographic image capturing apparatus according to a seventh aspect of the disclosed technology comprises: the radiation detector according to any one of 1 to 6 aspects; a first control circuit that performs control of accumulating a charge generated in each of the pixels in the pixel in a case where an operation mode is an accumulation mode, and performs control of reading out the charge accumulated in each of the pixels in a case where the operation mode is a read-out mode; a signal processor that generates image data based on the charge read out from each of the pixels in the read-out mode; and a second control circuit that performs control of making the operation mode of the first control circuit shift to the accumulation mode in a case where light emitted from the scintillator is detected by the light detection section.

According to the first aspect of the disclosed technology, it is possible for the light detector to appropriately detect light emitted from the scintillator.

According to the second aspect of the disclosed technology, it is possible for the light detector to appropriately detect light emitted from the scintillator.

According to the third aspect of the disclosed technology, absorption of light emitted from the scintillator by the substrate can be suppressed as compared with a case where the width of the deviation between the emission peak wavelength of the scintillator and the absorption wavelength edge of the substrate is less than 100 nm.

According to the fourth aspect of the disclosed technology, as compared to a case where no adhesion layer is provided, formation of an air layer between the substrate and the light detector can be suppressed, and reflection of light at an interface between the substrate and the light detector can be suppressed.

According to the fifth aspect of the disclosed technology, as compared with a case where the refractive index difference between the substrate and the adhesion layer and the refractive index difference between the light detector and the adhesion layer are each more than 10%, reflection of light at an interface between the substrate and the adhesion layer and an interface between the light detector and the adhesion layer can be suppressed.

According to the sixth aspect of the disclosed technology, a transmittance of the substrate for an X-ray emitted from an X-ray source for general imaging can be made to 99% or more.

According to the seventh aspect of the disclosed technology, it is possible for the light detector to appropriately detect light emitted from the scintillator.

What is claimed is:

1. A radiation detector comprising:
a substrate having a light-transmitting property;
a plurality of pixels provided on the substrate;
a scintillator laminated on a side of a first surface of the substrate; and
a light detector laminated on a side of a second surface of the substrate opposite to the first surface and including a photoelectric conversion film,
wherein an absorption peak wavelength, which is a wavelength having a highest absorbance, in a wavelength range of light absorbed by the photoelectric conversion film exists within an emission wavelength range which is a wavelength range of light emitted from the scintillator and is out of an absorption wavelength range which is a wavelength range of light absorbed by the substrate.

2. The radiation detector according to claim 1,
wherein the substrate is configured to include a polyimide having an absorption wavelength edge which is an edge of the absorption wavelength range of less than 500 nm, and
the absorption peak wavelength of the photoelectric conversion film is 500 nm or more.

3. The radiation detector according to claim 1,
wherein a width of a deviation between an emission peak wavelength, which is a wavelength having a highest emission intensity, in the emission wavelength range of the scintillator and an absorption wavelength edge which is an edge of the absorption wavelength range of the substrate is 100 nm or more.

4. The radiation detector according to claim 2,
wherein a width of a deviation between an emission peak wavelength, which is a wavelength having a highest emission intensity, in the emission wavelength range of the scintillator and an absorption wavelength edge which is an edge of the absorption wavelength range of the substrate is 100 nm or more.

5. The radiation detector according to claim 1, further comprising:
an adhesion layer provided between the substrate and the light detector.

6. The radiation detector according to claim 2, further comprising:
an adhesion layer provided between the substrate and the light detector.

7. The radiation detector according to claim 3, further comprising:
an adhesion layer provided between the substrate and the light detector.

8. The radiation detector according to claim 4, further comprising:
an adhesion layer provided between the substrate and the light detector.

9. The radiation detector according to claim 5,
wherein a refractive index difference between the substrate and the adhesion layer and a refractive index difference between the light detector and the adhesion layer are each 10% or less.

10. The radiation detector according to claim 6,
wherein a refractive index difference between the substrate and the adhesion layer and a refractive index difference between the light detector and the adhesion layer are each 10% or less.

11. The radiation detector according to claim 7,
wherein a refractive index difference between the substrate and the adhesion layer and a refractive index difference between the light detector and the adhesion layer are each 10% or less.

12. The radiation detector according to claim 8,
wherein a refractive index difference between the substrate and the adhesion layer and a refractive index difference between the light detector and the adhesion layer are each 10% or less.

13. The radiation detector according to claim 1,
wherein the substrate is configured to include a polyimide film having a thickness of 0.2 mm or less.

14. The radiation detector according to claim 2,
wherein the substrate is configured to include a polyimide film having a thickness of 0.2 mm or less.

15. The radiation detector according to claim 3,
wherein the substrate is configured to include a polyimide film having a thickness of 0.2 mm or less.

16. The radiation detector according to claim 4,
wherein the substrate is configured to include a polyimide film having a thickness of 0.2 mm or less.

17. A radiographic image capturing apparatus comprising:
the radiation detector according to claim 1;
a first control circuit that performs control of accumulating a charge generated in each of the pixels in the pixel in a case where an operation mode is an accumulation mode, and performs control of reading out the charge accumulated in each of the pixels in a case where the operation mode is a read-out mode;
a signal processor that generates image data based on the charge read out from each of the pixels in the read-out mode; and
a second control circuit that performs control of making the operation mode of the first control circuit shift to the accumulation mode in a case where light emitted from the scintillator is detected by the light detector.

18. A radiographic image capturing apparatus comprising:
the radiation detector according to claim 2;
a first control circuit that performs control of accumulating a charge generated in each of the pixels in the pixel in a case where an operation mode is an accumulation mode, and performs control of reading out the charge accumulated in each of the pixels in a case where the operation mode is a read-out mode;
a signal processor that generates image data based on the charge read out from each of the pixels in the read-out mode; and
a second control circuit that performs control of making the operation mode of the first control circuit shift to the accumulation mode in a case where light emitted from the scintillator is detected by the light detector.

19. A radiographic image capturing apparatus comprising:
the radiation detector according to claim 3;
a first control circuit that performs control of accumulating a charge generated in each of the pixels in the pixel in a case where an operation mode is an accumulation mode, and performs control of reading out the charge accumulated in each of the pixels in a case where the operation mode is a read-out mode;
a signal processor that generates image data based on the charge read out from each of the pixels in the read-out mode; and
a second control circuit that performs control of making the operation mode of the first control circuit shift to the accumulation mode in a case where light emitted from the scintillator is detected by the light detector.

20. A radiographic image capturing apparatus comprising:
the radiation detector according to claim 4;
a first control circuit that performs control of accumulating a charge generated in each of the pixels in the pixel in a case where an operation mode is an accumulation mode, and performs control of reading out the charge accumulated in each of the pixels in a case where the operation mode is a read-out mode;
a signal processor that generates image data based on the charge read out from each of the pixels in the read-out mode; and
a second control circuit that performs control of making the operation mode of the first control circuit shift to the accumulation mode in a case where light emitted from the scintillator is detected by the light detector.
